(19) United States
(12) Patent Application Publication
(10) Pub. No.: US 2025/0377634 A1
(43) Pub. Date: Dec. 11, 2025

(54) TIMEPIECE COMPONENT COMPRISING A SUBSTRATE MADE OF GLASS THAT IS TRANSPARENT TO VISIBLE LIGHT AND HAVING IMPROVED TENSILE STRENGTH

(71) Applicant: ASSOCIATION SUISSE POUR LA RECHERCHE HORLOGÈRE, Neuchâtel (CH)

(72) Inventors: Evelyne Vallat, Chézard-St-Martin (CH); Andreas Hogg, La Chenalotte (FR)

(73) Assignee: ASSOCIATION SUISSE POUR LA RECHERCHE HORLOGÈRE, Neuchâtel (CH)

(21) Appl. No.: 18/877,102

(22) PCT Filed: Jul. 3, 2023
(86) PCT No.: PCT/IB2023/056901

§ 371 Date: Dec. 19, 2024

(30) Foreign Application Priority Data
Jul. 6, 2022 (CH) 000810/2022
Jul. 6, 2022 (EP) 22183434.4

(51) Int. Cl. G04B 39/02; C03C 3/11; C03C 15/00; G04B 15/14

(52) U.S. Cl. CPC G04B 39/02; C03C 3/111; C03C 15/00; G04B 15/14

(57) ABSTRACT

A timepiece component with improved tensile strength, the component comprising a substrate made of glass that is transparent to visible light and having a lateral dimension of approximately a few centimetres or less and a thickness of approximately 5 millimetres or less. The substrate is coated with a passivation layer directly in contact with the surface of the substrate having a thickness of less than 1000 nm. The passivation layer comprises a refractory ceramic comprising at least 1 at. % hydrogen. The present invention also relates to a method for manufacturing this component.

### TECHNICAL FIELD

The present invention concerns a watch component comprising a glass substrate transparent to visible light and having improved resistance to breakage, as well as a method of manufacturing said component.

### BACKGROUND

Amorphous fused silica, or vitreous silica, (SiO₂) has the theoretical potential to achieve very high mechanical performance, defined by the Si—O interaction strength (breaking strength potential calculated at 17 GPa). In reality, vitreous silica's mechanical performance is reduced by the presence of defects (scratches, microcracks, microporosities, inclusions, etc.). These defects are often caused during the shaping of the vitreous silica component. These defects are generally the cause of slow crack growth. Slow crack growth can be likened to stress corrosion, which is caused by the presence of OH-ions in the ambient humidity, accelerating the propagation of cracks, the microscopic cause of brittle material failure. The miniaturization of the component reduces the probability of millimetric defects (scratches, microcracks), since a small component will have statistically fewer defects. The use of vitreous silica is therefore more interesting for the manufacture of small components, such as millimetric or sub-centimetric components, as in the case of micromechanical and watchmaking components.

Despite the beneficial potential of reducing the size of the mechanical component to exploit the performance of glassy silica, the inevitable increase in the surface-to-volume ratio and the effect of slow crack propagation make it necessary to implement a solution capable of reducing the surface density of defects and preventing (or at least reducing) the entry of ambient moisture (in particular OH-ions) into the component.

Furthermore, passivation layers have been developed for electronic devices in the single-crystal materials commonly used in optoelectronic applications (in particular: silicon, GaAs, etc.), whose main technical characteristic is the perfection of the single-crystal lattice essential to ensure optimal device operation. In these fields of application, current device performance is limited by the presence of defects (usually atomic) on the surface or at the interfaces.

In the field of electronic components (transistors) and photovoltaic (PV) devices based on monocrystalline silicon, it is well known that atomic defects on surfaces and/or at crystalline interfaces are the factors determining performance either when component size decreases, or, as in PV applications, when the density of volumetric defects in the material is insignificant.

The various passivation solutions developed in the electronics and PV sectors based on single-crystal silicon consist in coating the surface of the active volume with a thin, usually amorphous layer composed of amorphous silicon (a-Si:H), silicon oxide (SiO₂), silicon carbide (SiC), silicon nitride (Si3N4) or a composition resulting from their mixture (e.g. oxynitrides, silicon oxycarbide), or their combinations (e.g. SiO2+Si3N4) or their stacking sequence. e.g. oxynitrides, silicon oxycarbides), or their combinations (e.g. SiO2+Si3N4) or stacking sequence.

To limit the ingress of ambient humidity, the glass component can be coated with a kerosene layer or a polymer coating (parylene, ORMOCER, etc.). However, these types of coating are not suitable for the tribological stresses to which the component surface must respond in micromechanical and watchmaking applications.

It is also possible to use a type of glass that is more resistant than vitreous silica to slow crack propagation, such as aluminosilicate or borosilicate glass.

### SUMMARY

One aim of the invention is the application of an electronic-grade passivation layer to improve the mechanical performance of a visible-light-transparent glass in millimeter- to sub-centimeter-scale components. Here, the word “glass” refers to amorphous or nanocrystalline material. The expression “transparent to visible light” means transparent in a sufficient range of the wavelength range between 0.38 mm and 0.78 mm, to enable the human eye to perceive the presence of a background. Glass transparent to visible light will be referred to simply as “glass” in the remainder of this disclosure. Such glasses are of interest in the watchmaking field, particularly for the design of aesthetic components with high rigidity and environmental stability.

Another aim of the invention is to improve the mechanical performance, such as breaking strength, of transparent glass, for use in millimetre-to sub-millimetre-sized microcomponents, e.g. watch components.

According to the invention, these aims are achieved in particular by means of a passivation layer on the surface of a component so as to reduce the surface density of point defects (such as unordered or underordered bonds) and isolate the component from moisture (OH-ions) of atmospheric origin, which is responsible for accelerating the propagation of cracks leading to failure.

More particularly, the invention relates to a watch component with improved fracture resistance comprising a glass substrate having a lateral dimension of the order of centimeters or less and a thickness of the order of millimeters or less. The substrate is coated with a passivation layer, directly in contact with the substrate surface and having a thickness of less than 1000 nm, preferably less than 600 nm or more preferably less than 400 nm. The passivation layer comprises a refractory ceramic comprising at least 1% atomic hydrogen.

The low thickness of the passivation layer enables high dimensional accuracy of the component. This is particularly advantageous in micromechanical and watchmaking applications.

### BRIEF DESCRIPTION

Examples of implementation of the invention are indicated in the description illustrated by the appended figures in which:

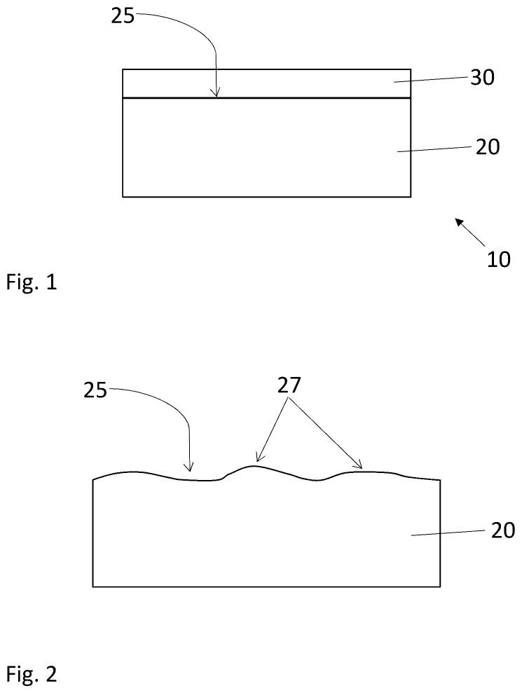

FIG. 1 schematically illustrates a micromechanical component comprising a substrate with a passivation layer, according to one embodiment;

FIG. 2 shows a schematic sectional view of the substrate surface, according to one embodiment;

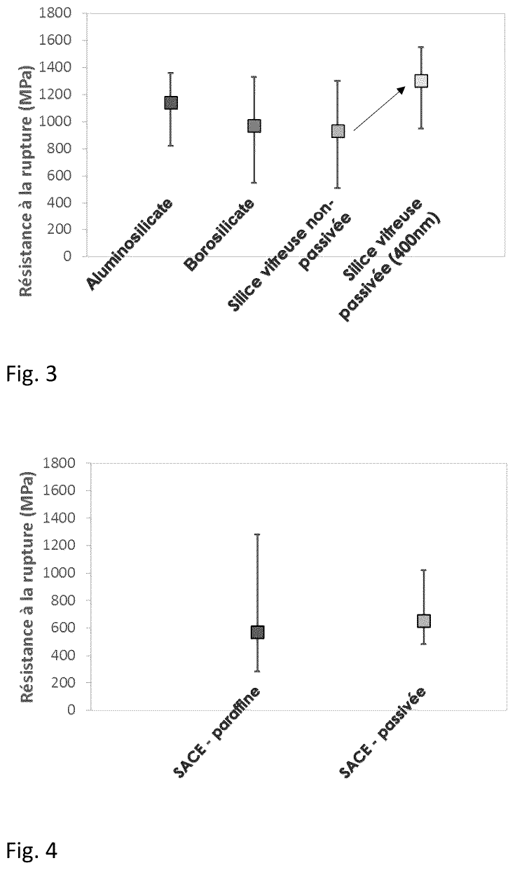

FIG. 3 shows bending strength tests for glass disks carried out by a B3B test; and

FIG. 4 shows meso-scale 3-point flexural strength tests performed on micro-tests.

### DETAILED DESCRIPTION

FIG. 1 shows, schematically, a watch component 10 comprising a substrate 20 of glass transparent to visible light having a lateral dimension of the order of a few centimeters or less and a thickness of the order of a millimeter or less. The substrate 20 is coated with a passivation layer 30, directly in contact with the surface 25 of the substrate 20.

The glass may comprise vitreous silica or a glass containing vitreous silica.

According to an embodiment, the passivation layer 30 has a thickness of less than 1000 nm, preferably less than 600 nm or more preferably less than 400 nm.

The passivation layer 30 comprises a refractory ceramic comprising at least 1 atomic % hydrogen.

The passivation layer 30 reduces the defect density of the substrate 20, improving, among other things, impact resistance. The passivation layer also insulates the substrate 20 (and thus the component 10) from ambient humidity, and thus from OH-ions present in the atmosphere, which are responsible for accelerating crack propagation leading to fracture. Depending on the choice of its chemical composition, the passivation layer 30 can also be used to preserve the aesthetic appearance (invisibility, transparency) of the initial component 10 machined into the substrate 20.

The choice of one or other of the chemical compositions of the passivation layer 30, as well as its thickness, can also depend on the characteristics required for the coating, e.g. resistance on the substrate, suitability for charge transport, transparency, conformity, deposition temperature, hardness, chemical barrier to ionic migration, tribological behavior, chemical compatibility with lubricants, etc.

In one embodiment, the refractory ceramic comprises one of the following: hydrogenated silicon oxynitride (SiON:H), hydrogenated silicon oxycarbide (SiOxCy:H), hydrogenated silicon carbide (SiC:H), hydrogenated silicon nitride (Si3N4:H), or a combination thereof.

The refractory ceramic passivation layer 30 comprising a SiON:H, SiOxCy:H, SiC:H or Si3N4:H ceramic, or a combination of these ceramics, ensures the visual transparency of the layer and is hermetically sealed against the transport of ions, in particular OH-ions, to the substrate 20.

A hydrogen content of the order of a few atomic percent saturates defects formed by unsaturated atomic bonds on the surface 25 of substrate 20. For example, on the surface 25 of a single-crystal silicon substrate, hydrogen reduces the density of dangling bonds. The importance and effects of hydrogen passivation are exploited in the semiconductor electronics industry and in photovoltaic applications. In the present invention, the passivation layer 30 comprising a refractory ceramic comprising at least 1 atomic % hydrogen improves the fracture toughness of component 10.

In the case of a brittle material, such as the glass making up the substrate 20, the resistance to rupture is inversely proportional to the density of defects potentially at the origin of a microcrack whose propagation will lead to the failure of the component 10.

The passivation layer comprising a refractory ceramic containing at least 1 atomic % hydrogen reduces the surface density of defects on the surface 25 of substrate 20. A reduction in the surface density of defects increases the mechanical strength, and in particular the fracture resistance, of component 10.

A thickness of less than 1000 nm, less than 600 nm or less than 400 nm enables the passivation layer 30 to act as a barrier to the penetration of impurities catalyzing or accelerating the propagation of microcracks, such as OH-ions in a vitreous silica substrate 20.

The performance of the passivation layer 30, in particular the reduction of the surface defect density of the substrate 20 and the isolation of the substrate 20 from ambient humidity, depends on the surface condition 25 of the substrate 20. For example, the surface 25 of substrate 20 must not be affected by machining. Defects such as scratches and microcracks on the surface 25 of substrate 20 should therefore be eliminated, or at least minimized.

In one embodiment, the surface 25 of substrate 20 on which passivation layer 30 is formed is smoothed, or polished, to a roughness Ra of less than 100 nm. FIG. 2 shows a schematic sectional view of surface 25. Preferably, surface 25 is levelled so that surface 25 of substrate 20 has a surface topology comprising asperities 27 or rounded dimples with a radius of curvature greater than 500 nm, preferably greater than 4 μm. The levelled surface 25 has no facets or sharp angles that could result in a possible concentration of stresses during mechanical loading.

Preferably, the surface 25 of substrate 20 should also be clean, i.e., have a controlled surface chemical state. Such a controlled surface chemical state can mean that the surface 25 of substrate 20 is substantially free of particulate contamination, native oxides (due to moisture and oxygen in the air), organic matter, coating residues, inorganic bases or acids, or other metallic contamination. In other words, the chemical composition at surface 25 is as close as possible to the mass chemical composition of substrate 20.

Flexural strength tests were carried out on glass discs with a diameter of 10 mm and a thickness of 0.2 mm. The glasses used include aluminosilicate glass, borosilicate glass and vitreous silica. The discs are polished on both sides by optical quality polishing resulting in a roughness Ra of less than 1 nm. The discs were measured with a SiON:H passivation layer 30, 400 nm in thickness, and without the passivation layer 30. Flexural strength tests were carried out using the “Ball on three balls” (B3B) test. The results of these tests, carried out in air and for 30 disks, are shown in FIG. 3.

In FIG. 3, the arrow shows the effect of the passivation layer on the distribution of flexural strength B3B, for vitreous silica discs with a SiON:H passivation layer and a thickness of 400 nm.

Meso-scale 3-point bending fracture tests were also carried out on micro-tubes with a 0.2 mm square cross-section. The micro-tubes were machined from SiO₂ wafers using a technique that preferably includes a chemical dissolution etching step.

This mechanism is essential to obtain machined surfaces of sufficient quality in terms of defects and residual machining stresses. The results of mesoscale 3-point bending tests are shown in FIG. 4.

In FIG. 4, the fracture toughness distribution is plotted for micro-tubes that have been machined using a spark-assisted chemical engraving (SACE) method. Unpassivated specimens are mechanically stressed with a paraffin coating (SACE-paraffin). Passivated specimens (SACE-passivated) feature a 400 nm SiON:H passivation layer and are loaded in air. Mechanical stress is applied to the machined faces. The passivation layer is considered functional if the mechanical performance measured in air on passivated specimens is at least equal to that measured on paraffin-coated specimens. The beneficial effect of passivation on mechanical performance can also be seen in the narrowing of the fracture strength distribution.

The results of FIGS. 3 and 4 show that, for both initial surface states of the vitreous silica, i.e. the optically polished surface 25 with Ra<1 nm for B3B tests, and the machined surface 25 for mesoscale tests, the passivation layer 30 improves mechanical performance.

In particular, the minimum strength of the specimens is improved. Statistical analysis of the B3B results (FIG. 3) shows a 25% improvement in the average fracture toughness of passivated vitreous silica discs polished on both sides. The results also show a narrower distribution of specimen fracture toughness.

In the case of bending tests carried out on disks in the B3B configuration, two thicknesses of passivation layer 30 were evaluated. Analysis of these results shows that the thickness of passivation layer 30 should preferably be equal to or less than 400 nm.

The study of the conformity of the growth of the passivation layer 30 (covering of an identical layer thickness on the protruding or re-entrant elements in the component) shows that all the surfaces of a component 10 gathering characteristic watchmaking elements such as escapement teeth, holes (diameter 3 mm to 0.2 mm), slender beam, tongue, point and re-entrant element, are satisfactorily coated by the passivation layer 30.

The substrate 20 can be coated with the passivation layer 30 on one, several or all of its surfaces 25. Preferably, the passivation layer 30 can be formed on all surfaces 25 of the substrate 20. Even more preferably, the three-dimensional component 10 has a passivation layer 30 of substantially uniform thickness on all its surfaces 25.

In one embodiment, the watch component may comprise a component of a display or an external component.

According to one embodiment, a method of manufacturing a watch component 10 comprises the steps of:
machining glass to form a substrate 20 having a lateral dimension of the order of centimeters or less and a thickness of the order of millimeters or less; and
forming a passivation layer 30 on the surface 25 of the substrate 20, the passivation layer 30 having a thickness of less than 1000 nm and comprising a refractory ceramic comprising at least 1 atomic % hydrogen.

The passivation layer 30 can be formed by a chemical vapor deposition process. In particular, the passivation layer 30 can be formed by a plasma-assisted chemical vapor deposition (PECVD) process dedicated to the three-dimensional uniform coating of component 10. For example, the passivation layer 30 can be formed in a reactor comprising rotating/mixing/returning means that facilitate uniform deposition of the passivation layer 30 on one or a plurality of three-dimensional components 10, as described in Swiss patent application CH715599. To ensure that deposition of the passivation layer 30 does not cause additional defects on the surface 25, low-temperature, gentle coating processes, such as thermal growth or PECVD layer deposition, are preferred.

In one embodiment, the process may further comprise a step of chemical vapor or liquid phase dissolution of the surface 25 of the substrate 20, prior to the step of forming the passivation layer 30.

The step of machining the substrate 20 may comprise selectively chemically dissolving the substrate 20 and releasing the machined component 10.

According to one embodiment, the machining step may comprise one of the following processes: deep reactive-ion etching (DRIE), spark assisted chemical engraving (SACE), or very short pulse laser marking (femto to pico seconds). The machining step can optionally be followed by selective chemical dissolution of the marked volume (or selective laser engraving).

Other machining methods, such as light induced deep etching (LIDE) or selective laser etching (SLE), all of which include a chemical dissolution step for releasing the machined component 10, can also be used within the scope of the present invention.

According to one embodiment, the process comprises a step of smoothing and/or levelling the surface 25 of substrate 20 so as to obtain rounded asperities or dimples with a radius of curvature greater than 500 nm, preferably greater than 4 μm. The smoothing and/or levelling step may also include polishing the surface 25 receiving the passivation layer 30. Preferably, polishing is carried out with an optical quality resulting in a roughness Ra of less than 1 nm. The step of smoothing and/or levelling the surface 25 is carried out prior to the formation of the passivation layer 30.

In one embodiment, the process comprises a surface cleaning step, carried out prior to the formation of the passivation layer 30, to achieve a controlled chemical state of the surface, i.e. the surface 25 is substantially free from contamination by particles, native oxides (due to humidity and oxygen in the air), organic matter, layer residues, inorganic bases or acids, or other metallic contamination. The surface cleaning step is carried out before the passivation layer 30 is formed.

### REFERENCE NUMBERS USED ON FIGURES

10 component
20 substrate
25 surface
27 roughness
30 passivation layer

1. A watch component with improved breakage resistance, comprising
a glass substrate transparent to visible light and having a lateral dimension of the order of a few centimetres or less and a thickness of the order of millimetres or less;
the substrate being coated with a passivation layer, directly in contact with the surface of the substrate and having a thickness of less than 1000 nm, the passivation layer comprising at least one refractory ceramic comprising at least 1% atomic hydrogen.

2. The watch component according to claim 1, wherein the passivation layer has a thickness of less than 600 nm and preferably less than 400 nm.

3. The watch component according to claim 1, wherein the refractory ceramic comprises hydrogenated silicon oxynitride (SiON:H), hydrogenated silicon oxycarbide (SiOxCy:H), hydrogenated silicon carbide (SiC:H), hydrogenated silicon nitride (Si3N4:H), or a combination of these ceramics as well as the stacking thereof.

4. The watch component according to claim 1, wherein the surface of the substrate has a roughness Ra of less than 100 nm.

5. The watch component according to claim 4, wherein the surface of the substrate comprises asperities having a radius of curvature exceeding 4 μm.

6. The watch component according to claim 1, wherein the glass comprises vitreous silica or a glass containing vitreous silica.

7. The watch component according to claim 1, comprising a mechanically stressed component.

8. The watch component according to claim 1, comprising a component of a display device or an external watch part.

9. A process for manufacturing a watch component, comprising a glass substrate transparent to visible light and having a lateral dimension of the order of a few centimetres or less and a thickness of the order of millimetres or less; wherein the substrate is coated with a passivation laver, directly in contact with the surface of the substrate and having a thickness of less than 1000 nm, the passivation layer comprising at least one refractory ceramic comprising at least 1% atomic hydrogen;
the process comprising the steps of:
machining the glass so as to form the substrate having a lateral dimension of the order of centimetres or less and a thickness of the order of millimetres or less;
forming the passivation layer on the surface of the substrate, the passivation layer having a thickness of less than 1000 nm and comprising at least one refractory ceramic comprising at least 1% atomic hydrogen.

10. The process according to claim 9, wherein the passivation layer is formed by a chemical vapour deposition process.

11. The process according to claim 10, wherein the passivation layer is formed by a plasma assisted chemical vapour deposition (PECVD) process.

12. The process according to claim 9, comprising a step of smoothing and/or levelling the surface of the substrate, so as to obtain a surface topology comprising asperities having a radius of curvature exceeding 500 nm, preferably exceeding 4 μm.

13. The process according to claim 9, further comprising a step of chemical dissolution in the vapour or liquid phase of the surface of the substrate, prior to the step of forming the passivation layer.

14. The process according to claim 9, wherein the step of machining the substrate comprises selectively chemically dissolving the substrate and releasing the machined component.
